(19) United States
(12) Patent Application Publication
(10) Pub. No.: US 2011/0025659 A1
(43) Pub. Date: Feb. 3, 2011

(54) ORGANIC LIGHT EMITTING DISPLAY DEVICE

(76) Inventors: Won-Kyu Kwak, Yongin-city (KR); Dong-Wook Park, Yongin-city (KR); Sang-Moo Choi, Yongin-city (KR)

Correspondence Address: CHRISTIE, PARKER & HALE, LLP, PO BOX 7068, PASADENA, CA, 91109-7068, US

(21) Appl. No.: 12/774,638

(22) Filed: May 5, 2010

(30) Foreign Application Priority Data
Jul. 29, 2009 (KR) 10-2009-0069426

(51) Int. Cl. G09G 3/30; G09G 5/00

(52) U.S. Cl. 345/205; 345/80

(57) ABSTRACT

An organic light emitting display device may include a plurality of pixels in pixel regions defined on a substrate, each of the pixels being coupled to a current scan line, a data line, a first power source, a second power source and a third power source, wherein each of the pixels includes a pixel circuit having a plurality of transistors and one or more capacitors, and an organic light emitting diode (OLED) including a first electrode and coupled to the pixel circuit, the OLED configured to emit light with a luminance corresponding to a driving current flowing from the first power source to the second power source via the pixel circuit, wherein the third power source is configured to supply a constant voltage to the pixel circuit through a supply line, and wherein the supply line is in a same layer and of a same material as the first electrode.

### CROSS-REFERENCE TO RELATED APPLICATIONS

This application claims priority to and the benefit of Korean Patent Application No. 10-2009-0069426, filed on Jul. 29, 2009, in the Korean Intellectual Property Office, the entire content of which is incorporated herein by reference.

### BACKGROUND

1. Field

An aspect of the present invention generally relates to an organic light emitting display device.

2. Description of the Related Art

An organic light emitting display device is a type of flat panel display device that uses an organic compound as a light emitting material. As such, the organic light emitting display device has been expected to be used for various types of display devices including a portable display device because of high luminance and color purity, thin, lightweight and low power consumption characteristics.

An organic light emitting display device typically includes a plurality of pixels each having an organic light emitting diode as a self-luminescent element. In the case of an active matrix organic light emitting display device, a pixel circuit is further provided with each pixel. The pixel circuit includes a plurality of transistors for driving the organic light emitting diode and one or more capacitors.

Typically, an active matrix organic light emitting display device is manufactured by forming pixel circuits on a substrate and then forming an organic light emitting diode on each of the pixel circuits so that the organic light emitting diode is connected to the pixel circuit through a via hole.

As compensation elements are added to the pixel circuits, for compensating for characteristic variations of the transistors due to the process variations, the configuration of the pixel circuits has become complicated.

As such, it can be difficult to secure sufficient space for forming capacitors due to limitations of the design space in a limited pixel region. As a result, image quality can be unequal or non-uniform. Further, because it is difficult to secure sufficient spacing between wires, yield is lowered.

### SUMMARY

Accordingly, in several embodiments, there is provided an organic light emitting display device capable of displaying uniform images and improving a yield by simplifying the design of a pixel circuit through effective arrangement of wires and other circuit components.

According to an aspect of the present invention, there is provided an organic light emitting display device including a plurality of pixels in pixel regions defined on a substrate, each of the pixels being coupled to at least a current scan line, a data line, a first power source, a second power source and a third power source, wherein each of the pixels includes a pixel circuit having a plurality of transistors and one or more capacitors, and an organic light emitting diode including a first electrode and coupled to the pixel circuit, the organic light emitting diode configured to emit light with a luminance corresponding to a driving current flowing from the first power source to the second power source via the pixel circuit, wherein the third power source is configured to supply a constant voltage to the pixel circuit through a supply line of the third power source, and wherein the supply line is formed in a same layer and of a same material as the first electrode.

Here, the third power source may be a power source that does not form a current path to the organic light emitting diode. The third power source may be configured to supply a constant voltage to the pixel circuit during the period before a current scan signal is supplied from the current scan line.

The supply line of the third power source may be formed of the same material as that of an anode electrode of the organic light emitting diode in the same layer.

A supply line of the first power source may be formed in a different layer from that in which the supply line of the third power source is formed. Here, the supply line of the first power source may be formed of the same material and in the same layer as that of one electrode of the transistor.

The first power source may be configured as a high-potential pixel power source, and the second power source may be configured as a low-potential pixel power source. The third power source may be set to a different voltage than the first power source and the second power source.

The pixel circuit may include a plurality of transistors formed on the substrate, and one or more capacitors formed using a same material as an electrode material of the transistors during the same process of forming the transistors. The organic light emitting diode may be formed on the pixel circuit with an insulating layer interposed therebetween, and the first electrode of the organic light emitting diode may be coupled to a source or drain electrode of the transistors through a via hole in the insulating layer.

Here, the organic light emitting diode may include an anode electrode formed on the insulating layer, an organic emission layer formed on the anode electrode and a cathode electrode formed on the organic emission layer. The organic light emitting diode may emit light in the direction of the cathode electrode.

The anode electrode of the organic light emitting diode and the supply line of the third power source may be formed of a material selected from the group consisting of ITO/Ag/ITO, ITO/Al/ITO, ITO/AlNiLa/ITO and ITO/AlNiLa.

According to one embodiment of the present invention, a supply line for supplying a third power source is not configured to form a current path to an organic light emitting diode unlike the high-potential and low-potential pixel power sources which may form such a current path. The supply line may be formed of the same material as that of one electrode of the organic light emitting diode, (i.e., an anode electrode of an organic light emitting diode in the same layer). In such case, wires of the pixels may be effectively arranged.

Accordingly, in several embodiments, the design of a pixel circuit positioned below the organic light emitting diode is simplified, so that an organic light emitting display device may display uniform images and may improve yield by sufficiently ensuring space for forming capacitors, spacing between wires, and other appropriate spacing for circuit components.

### BRIEF DESCRIPTION OF THE DRAWINGS

The accompanying drawings, together with the specification, illustrate exemplary embodiments of the present invention, and, together with the description, serve to explain aspects of the present invention.

FIG. 1 is a block diagram of an organic light emitting display device including a number of pixels according to one embodiment of the present invention.

FIG. 2 is a schematic circuit diagram illustrating an embodiment of one of the pixels illustrated in FIG. 1.

FIG. 3 is a waveform diagram illustrating a method for driving the pixel illustrated in FIG. 2 according to one embodiment of the present invention.

FIG. 4 is a cross sectional view illustrating a portion of the pixel illustrated in FIG. 2 according to one embodiment of the present invention.

FIG. 5 is a schematic circuit diagram illustrating another embodiment of the pixel illustrated in FIG. 1.

FIG. 6 is a waveform diagram illustrating a method for driving the pixel illustrated in FIG. 5 according to one embodiment of the present invention.

FIG. 7 is a cross sectional view illustrating a portion of the pixel illustrated in FIG. 5 according to one embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

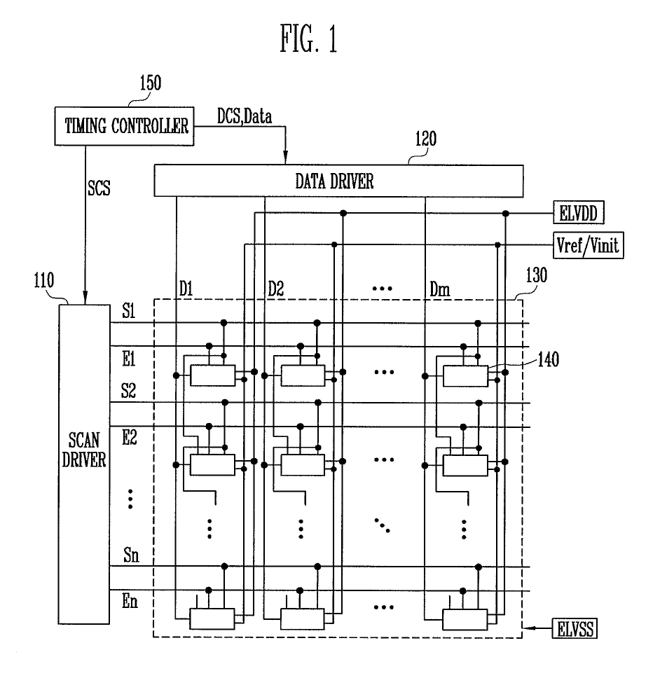

FIG. 1 is a block diagram of an organic light emitting display device including a number of pixels according to one embodiment of the present invention.

Referring to FIG. 1, the organic light emitting display device includes a display region 130 having a plurality of pixels 140 coupled to scan lines S1 to Sn, emission control lines E1 to En and data lines D1 to Dm; a scan driver 110 for driving the scan lines S1 to Sn and the emission control lines E1 to En; a data driver 120 for driving the data lines D1 to Dm; and a timing controller 150 for controlling the scan driver 110 and the data driver 120.

The display region 130 includes a plurality of pixels 140 formed in regions defined by the scan lines S1 to Sn, the emission control lines E1 to En and the data lines D1 to Dm. The display region 130 receives a first power source ELVDD, a second power source ELVSS and a third power source Vref/Vinit. Each of the three power sources may be sources external to the display region 130.

More specifically, the plurality of pixels 140 are formed in pixel regions defined on a substrate, respectively. A pixel 140 positioned on an i-th row (the “i” is a natural number) and a j-th column (the “j” is a natural number) is coupled to at least a current scan line Si, a data line Dj, the first power source ELVDD, the second power source ELVSS and the third power source Vref/Vinit. When a current scan signal is supplied from the current scan line Si, the pixel 140 stores a data signal supplied from the data line Dj and emits light with luminance corresponding to the data signal.

To this end, each of the pixels 140 includes a pixel circuit including a plurality of transistors and one or more capacitors; and an organic light emitting diode coupled to the pixel circuit to emit light with luminance corresponding to a driving current flowing from the first power source ELVDD to the second power source ELVSS via the pixel circuit and the organic light emitting diode. Here, the first power source ELVDD is set as a high-potential (i.e., high voltage) pixel power source, and the second power source ELVSS is set as a low-potential (i.e., low voltage) pixel power source.

However, in one embodiment of the present invention, the pixels 140 may further include compensation elements for compensating for threshold voltage variations of the driving transistors and other variations. In this case, the third power source Vref/Vinit is used. The third power source Vref/Vinit is configured as a voltage source for supplying a constant voltage to the pixels 140. The third power source Vref/Vinit may be configured as a reference power source Vref having a higher voltage than that of the data signal, an initialization power source Vinit having a lower voltage than that of the data signal, or as another suitable power source. The third power source may be variously changed depending on the configuration of pixels.

The third power source Vref/Vinit may be configured to supply the respective pixels 140 before the current scan signal is supplied from the current scan line Si. For example, the pixels 140 are further coupled to the previous scan line Si-1 so that an initializing process using the third power source Vref/Vinit and/or a threshold-voltage compensating process may be performed when the previous scan signal is supplied from the previous scan line Si-1 and so that a voltage corresponding to the data signal may be stored when the current scan signal is supplied from the current scan line Si. Although not illustrated in FIG. 1, a zeroth scan line S0 (not shown) may be additionally formed to be coupled to the pixels 140 positioned on the first row.

The timing controller 150 generates a data driving control signal DCS and a scan driving control signal SCS, corresponding to synchronization signals supplied from external control circuitry. The data driving control signal DCS generated from the timing controller 150 is supplied to the data driver 120, and the scan driving control signal SCS generated from the timing controller 150 is supplied to the scan driver 110. The timing controller 150 also supplies a data signal Data supplied from the external control circuitry to the data driver 120.

The scan driver 110 receives the scan driving control signal SCS supplied from the timing controller 150. The scan driver 110 sequentially supplies scan signals to the scan lines S1 to Sn, and sequentially supplies emission control signals to the emission control lines E1 to En. Here, the emission control signal may be supplied to overlap with at least two scan signals, i.e., previous and current scan signals, during at least some periods. To this end, the width of emission control signals (i.e., a duration of the emission control signals) may be set wider than that of scan signals.

The data driver 120 receives a data driving control signal DCS supplied from the timing controller 150. The data driver 120 then generates data signals and supplies the generated data signals to the data lines D1 to Dm.

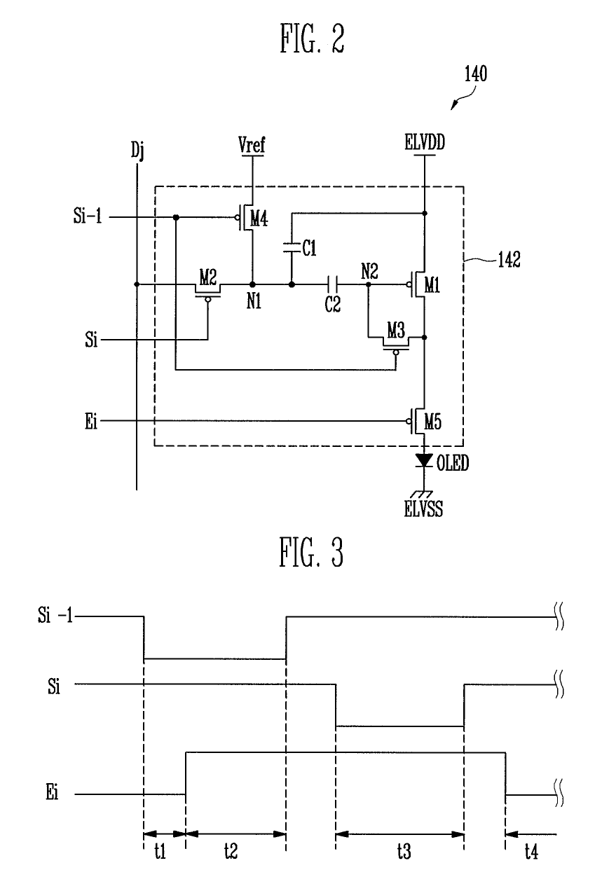

FIG. 2 is a schematic circuit diagram illustrating an embodiment of a pixel 140 illustrated in FIG. 1. For convenience of illustration, a pixel positioned on an i-th row (the “i” is a natural number) and a j-th column (the “j” is a natural number) is illustrated in FIG. 2.

Referring to FIG. 2, the pixel 140 includes a pixel circuit 142 having a plurality of transistors M1 to M5 and capacitors C1 and C2; and an organic light emitting diode OLED for receiving a driving current supplied from the pixel circuit 142. In other embodiments, pixel circuit 142 may include additional capacitors.

When a previous scan signal is provided from a previous scan line Si-1, the pixel circuit 142 may compensate for the voltage drop of the first power source ELVDD and the threshold voltage of the first transistor M1 (driving transistor). When a current scan signal is supplied from a current scan line Si, the pixel circuit 142 stores a voltage corresponding to a data signal and then supplies a driving current corresponding to the data signal to the organic light emitting diode OLED.

To this end, the pixel circuit 142 is connected to the current scan line Si, the previous scan line Si-1, an emission control line Ei, a data line Dj, the first power source ELVDD, a third power source Vref and the organic light emitting diode OLED. The pixel circuit 142 includes first to fifth transistors M1 to M5, and first and second capacitors C1 and C2.

The first transistor M1 is coupled between the first power source ELVDD and the organic light emitting diode OLED to control a driving current corresponding to a voltage applied to a gate electrode of the first transistor M1.

More specifically, a first electrode (i.e., a source electrode) of the first transistor M1 is coupled to the first power source ELVDD, and a second electrode (i.e., a drain electrode) of the first transistor M1 is coupled to the organic light emitting diode OLED via the fifth transistor M5. The gate electrode of the first transistor M1 is coupled to a second node N2. The first transistor M1 controls the driving current supplied to the organic light emitting diode OLED. The driving current may correspond to the voltage at the second node N2, which corresponds to the voltage stored in the first and second capacitors C1 and C2.

The second transistor M2 is coupled between the data line Dj and a first node N1. When the current scan signal is supplied from the current scan line Si, the second transistor M2 allows a data signal to be supplied to the pixel 140.

More specifically, a first electrode of the second transistor M2 is coupled to the data line Dj, and a second electrode of the second transistor M2 is coupled to the first node N1. Here, the first node N1 is a connection node of the second and fourth transistors M2 and M4 and the first and second capacitors C1 and C2. A gate electrode of the second transistor M2 is coupled to the current scan line Si. When the current scan signal is supplied from the current scan line Si, the second transistor M2 is turned on to allow a data signal from the data line Dj to be supplied to the first node N1.

The third transistor M3 is coupled between the gate electrode and second electrode (drain electrode) of the first transistor M1. The third transistor M3 allows the first transistor M1 to be diode-coupled when a voltage is applied to a gate electrode of the third transistor M3.

More specifically, a first electrode of the third transistor M3 is coupled to the second electrode of the first transistor M1, and a second electrode of the third transistor M3 is coupled to the second node N2. The gate electrode of the third transistor M3 is coupled to the previous scan line Si-1. When the previous scan signal is supplied from the previous scan line Si-1, the third transistor M3 is turned on to allow the first transistor M1 to be diode-coupled.

The fourth transistor M4 is coupled between the first node N1 and the third power source Vref. The fourth transistor M4 is turned on by the previous scan signal to allow the voltage of the third power source Vref to be supplied to the first node N1. Here, the third power source Vref does not form a current path to the organic light emitting diode unlike the first power source ELVDD and the second power source ELVSS. The third power source Vref instead supplies a constant voltage to the pixel circuit 142 during the period before the current scan signal is supplied from the current scan line Si (i.e., the period in which the previous scan signal is provided from the previous scan line Si-1). The third power source Vref is configured as a reference power source having a voltage higher than that of the data signal and lower than that of the first power source ELVDD.

More specifically, a first electrode of the fourth transistor M4 is coupled to the third power source Vref, and a second electrode of the fourth transistor M4 is coupled to the first node N1. A gate electrode of the fourth transistor M4 is coupled to the previous scan line Si-1. When the previous scan signal is supplied from the previous scan line Si-1, the fourth transistor M4 is turned on to allow the third power source Vref to be coupled to the first node N1. Then, the voltage of the third power source Vref is supplied, via the first node N1, to the first and second capacitors C1 and C2.

The fifth transistor M5 is coupled between the first transistor M1 and the organic light emitting diode OLED. The switching (i.e., turning on/off) of the fifth transistor M5 is controlled by an emission control signal supplied from the emission control line Ei.

More specifically, a first electrode of the fifth transistor M5 is coupled to the second electrode of the first transistor M1, and a second electrode of the fifth transistor M5 is coupled to an anode electrode of the organic light emitting diode OLED. A gate electrode of the fifth transistor M5 is coupled to the emission control line Ei. When the voltage level of the emission control signal supplied from the emission control line Ei is at a high level, the fifth transistor M5 is turned off to allow the pixel circuit 142 to be isolated from the organic light emitting diode OLED. When the voltage of the emission control signal is changed from the high level to a low level, the fifth transistor M5 is turned on to allow the driving current supplied from the first transistor M1 to be supplied to the organic light emitting diode OLED.

The first capacitor C1 is coupled between the first node N1 and the first power source ELVDD. Here, a second electrode of the first capacitor C1 is coupled to the gate electrode of the first transistor M1 via the second capacitor C2. The first capacitor C1 allows a voltage corresponding to the data signal to be stored therein and maintains the stored voltage during the period in which the pixel 140 emits light.

The second capacitor C2 is coupled between the first and second nodes N1 and N2. The second capacitor C2 allows a compensation voltage to be stored therein and maintains the stored voltage during the period in which the pixel 140 emits light. Here, the compensation voltage includes compensation for both the threshold voltage of the first transistor M1 and the voltage drop of the first power source ELVDD.

In FIG. 2, the first power source ELVDD is coupled to each of the pixels 140 to supply a current (i.e., predetermined current) to the pixel 140. That is, the first power source ELVDD is a power source for forming a current path to the organic light emitting diode. In accordance with the positions of the pixels 140, a voltage drop/loss may occur in the voltage of the first power source ELVDD supplied to each of the pixels 140. However, in the embodiment illustrated in FIG. 2, the third power source Vref is a power source that does not supply driving current to the respective pixels 140, i.e., a power source that does not form a current path to the organic light emitting diode. As such, the third power source Vref may maintain the same voltage regardless of the positions of the pixels 140. Here, the voltage of the third power source Vref may be set to a voltage level higher than that of the data signal. The voltage of the third power source Vref may also be set to a voltage level lower than or identical to that of the first power source ELVDD.

The organic light emitting diode OLED is coupled between the pixel circuit 142 and the second power source ELVSS to emit light with a luminance corresponding to the driving current flowing from the first power source ELVDD to the second power source ELVSS via the pixel circuit 142 and the organic light emitting diode OLED. The organic light emitting diode OLED includes an organic emission layer for emitting light of red, green or blue so as to generate light of the color corresponding to the driving current.

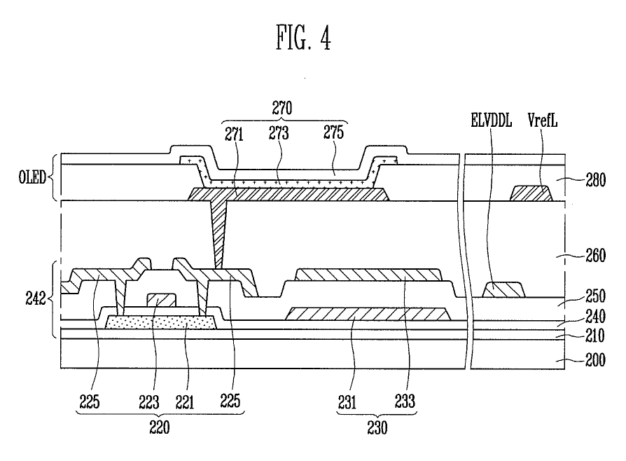

FIG. 3 is a waveform diagram illustrating a method for driving the pixel illustrated in FIG. 2 according to one embodiment of the present invention.

Referring to FIG. 3, the pixel 140 receives low-level previous and current scan signals, sequentially supplied from the previous and current scan lines (Si-1 and Si). The pixel 140 also receives a high-level emission control signal, supplied from the emission control line Ei. Here, the high-level emission control signal overlaps with low level portions of the previous scan signal and the current scan signal.

After the supply of the previous scan signal is started (i.e., driven to a low-level), the emission control signal is changed to a high-level voltage at which the fifth transistor M5 is turned off. After the supply of the current scan signal is finished (i.e., driven to a high level), the emission control signal is changed to a low-level voltage at which the fifth transistor M5 is turned on.

Meanwhile, the pixel 140 receives the first power source ELVDD, the second power source ELVSS and the third power source Vref, supplied from sources external to the pixel. The pixel 140 receives a data signal supplied from the data line Dj.

The pixel 140 compensates for the variation between the voltage drop of the first power source ELVDD and the threshold voltage of the first transistor M1, using the difference between the first power source ELVDD and the third power source Vref.

More specifically, the emission control signal maintains a low level during a first period t1 that is a portion of the period in which the previous scan signal is supplied from the previous scan line Si-1. Accordingly, the fifth transistor M5 maintains a turned-on state during t1. The third and fourth transistors M3 and M4 are turned on by a low-level previous scan signal during the first period t1.

If the third transistor M3 is turned on during the first period t1, the gate electrode of the first transistor M1 is electrically coupled to the organic light emitting diode OLED via the third transistor M3. Therefore, the voltage at the gate electrode of the first transistor M1, i.e., the voltage at the second node N2, is initialized to about the voltage of the second power source ELVSS. That is, during the first period t1, that is a portion of the period in which the previous scan signal is supplied from the previous scan line Si-1, the voltage at the second node N2 is initialized.

Thereafter, if the voltage level of the emission control signal supplied from the emission control line Ei is changed to a high level, during a second period t2, the fifth transistor M5 is turned off except during the first period t1. Then, a voltage obtained by subtracting the threshold voltage of the first transistor M1 from the first power source ELVDD is applied to the gate electrode of the first transistor M1 diode-coupled by the third transistor M3.

The first node N1 is charged with the voltage of the third power source Vref by the fourth transistor M4 maintaining a turned-on state during the second period t2. Here, the voltage of the third power source Vref may be set higher than that of the data signal and/or set identical to or lower than that of the first power source ELVDD. For convenience of illustration, it is assumed that the voltage of the third power source Vref is identical to that of the first power source ELVDD. Then, a voltage corresponding to the threshold voltage of the first transistor M1 is stored in the second capacitor C2. If a voltage drop is generated from the first power source ELVDD, the threshold voltage of the first transistor M1 and the voltage drop of the first power source ELVDD are stored in the second capacitor C2. Accordingly, it is possible to concurrently compensate for the voltage drop of the first power source ELVDD and the threshold voltage of the first transistor M1.

Thereafter, if the current scan signal is supplied from the current scan line Si, the second transistor M2 is turned on during a third period t3. If the second transistor M2 is turned on, the data signal supplied from the data line Dj is supplied to the first node N1. Therefore, the voltage at the first node N1 is dropped from the third power source Vref to the voltage of the data signal. Then, the voltage at the second node N2, which is set as a floating state during the third period t3, is also dropped corresponding to the voltage drop at the first node N1. That is, the voltage stored in the second capacitor C2 is stably maintained during the third period t3. Meanwhile, the first capacitor C1 is charged with a voltage corresponding to the data signal supplied to the first node N1 during the third period t3.

Thereafter, if the voltage level of the emission control signal is changed to a low level at which the fifth transistor M5 is turned on after the supply of the current scan signal is stopped, the fifth transistor M5 is turned on during a fourth period t4. If the fifth transistor M5 is turned on, the first transistor M1 supplies a driving current corresponding to the voltage stored in the first and second capacitors C1 and C2 to the organic light emitting diode OLED. Therefore, the organic light emitting diode OLED emits light with luminance corresponding to the driving current.

Accordingly, the pixel 140 emits light with a desired luminance corresponding to the data signal, regardless of the threshold voltage of the driving transistor (first transistor M1) and the voltage drop of the first power source ELVDD.

FIG. 4 is a cross sectional view illustrating a portion of the pixel illustrated in FIG. 2 according to one embodiment of the present invention. For convenience of illustration, only one transistor (i.e., the fifth transistor) and one capacitor (i.e., the first capacitor) are illustrated in FIG. 4. The transistor and the capacitor are referred to using general terms, i.e., a thin film transistor and a capacitor, respectively.

That is, although not illustrated in FIG. 4, a pixel circuit formed in each of the pixel regions may include a plurality of transistors formed on a substrate, and one or more capacitors formed in the same process of forming the plurality of transistors.

Referring to FIG. 4, a pixel circuit 242, including a thin film transistor 220 and a capacitor 230, is formed on a substrate 200. In several embodiments, pixel circuit 242 is representative of one or more components of pixel circuit 142 of FIG. 2. An organic light emitting diode 270 connected to the thin film transistor 220 is formed on the pixel circuit 242.

More specifically, the thin film transistor 220 includes a semiconductor layer 221 formed at an upper portion of a buffer layer 210 on the substrate 200; a gate electrode 223 formed on the semiconductor layer 221 with a gate insulating layer 240 interposed therebetween; and source and drain electrodes 225 formed at upper portions of an interlayer insulating layer 250 on the gate electrode 223. The source and drain electrodes 225 are connected to source and drain regions of the semiconductor layer 221 through contact holes, respectively.

The capacitor 230 includes a first electrode 231 formed on the gate insulating layer 240, and a second electrode 233 formed opposite to the first electrode 231 on the interlayer insulating layer 250 interposed therebetween.

Here, the first electrode 231 of the capacitor 230 may be formed of the same material as that of the gate electrode 223 in the same layer during the process of forming the gate electrode 223 of the thin film transistor 220. The second electrode 233 of the capacitor 230 may be formed of the same material as that of the source and drain electrodes 225 in the same layer during the process of forming the source and drain electrodes 225 of the thin film transistor 220.

Although one embodiment of the capacitor 230 is illustrated in FIG. 4, the configuration of the capacitor 230 is not limited thereto. For example, the capacitor 230 may further include another semiconductor layer formed of the same material as that of the semiconductor layer 221 in the same layer during the process of forming the semiconductor layer 221 of the thin film transistor 220.

A planarization film 260 having an insulating property is formed on the thin film transistor 220 and the capacitor 230, and an organic light emitting diode 270 is formed on the planarization film 260.

The organic light emitting diode 270 includes an anode electrode 271 formed on the planarization layer 260 and connected to the source or drain electrode 225 of the thin film transistor 220 through a via hole passing through the planarization layer 260. The organic light emitting diode 270 further includes an organic emission layer 273 formed on the anode electrode 271, and a cathode electrode 275 formed on the organic emission layer 273. Reference numeral 280 designates a pixel defining layer.

In one embodiment of the present invention, a first power source supply line ELVDDL for supplying the first power source ELVDD may be formed using an electrode material of the thin film transistor 220 during the process of forming the pixel circuit 242. That is, the first power source supply line ELVDDL may be formed of the same material as that of one electrode of the thin film transistor 220 on the same layer.

Particularly, when the first power source supply line ELVDDL is coupled to the source electrode of the first transistor M1 and one electrode of the first capacitor C1 as illustrated in FIG. 2, the first power source supply line ELVDDL may be patterned to be coupled to the source electrode of the first transistor M1 and the one electrode of the first capacitor C1 during the process of forming the source and drain electrodes 225 of the thin film transistor 220. That is, the first power source supply line ELVDDL may be connected to the source electrode of the first transistor M1 and the one electrode of the first capacitor C1 in a region (not shown).

Meanwhile, the first to fifth transistors M1 to M5 in FIG. 2 may be simultaneously formed. In the embodiment illustrated in FIG. 4, sections of the first to fifth transistors M1 to M5 are exemplified by a section of the thin film transistor 220 for convenience of illustration.

A third power source supply line VrefL for supplying a third power source Vref may be formed using an electrode material of the organic light emitting diode 270 during the process of forming the organic light emitting diode 270. That is, the third power source supply line VrefL may be formed of the same material and in the same layer as that of one electrode of the organic light emitting diode 270. Particularly, the third power source supply line VrefL may be formed of the same material and in the same layer as that of the anode electrode 271.

In one embodiment, the third power source supply line VrefL is connected to the fourth transistor M4 illustrated in FIG. 2 through another via hole (not shown) passing through the planarization layer 260.

During the process of forming a via hole for connecting the third power source supply line VrefL to the fourth transistor M4, even if the pixels become non-uniform due to the high contact resistance through the via hole, current does not flow into the third power source supply line VrefL. Consequently, the luminance of the pixels is not affected.

That is, in one embodiment of the present invention, the third power source supply line VrefL having no current path formed to the organic light emitting diode is disposed in on upper layer of the pixel, i.e., the layer having the anode electrode 271 of the organic light emitting diode 270 formed therein, so as to be connected to the pixel circuit 242 through a via hole or the like.

As described above, the formation position of the third power source supply line VrefL may be changed from the layer in which the pixel circuit 242 is formed to the upper layer in which the organic light emitting diode 270 is formed, thereby simplifying the design of the pixel circuit 142. Accordingly, the organic light emitting display device may display uniform images and improve yield by ensuring a space for forming the capacitor 230 and/or spacing between wires.

Further, the first power source supply line ELVDDL and the like are disposed in the pixel circuit 242, so that vias are not needed and contact resistance distribution may be minimized. For example, the second power source ELVSS (not shown) may be connected to the cathode electrode 275 by a second power source supply line (not shown) connected to the cathode electrode 275 formed at a region outside of the display region in the display region structure in which the cathode electrode 275 is entirely formed in a plate shaped region of the display region.

Meanwhile, when the organic light emitting diode 270 is a front-emission-type organic light emitting diode for emitting light in a direction of the cathode electrode 275, the anode electrode 271 may be formed of any material selected from the group consisting of ITO/Ag/ITO, ITO/Al/ITO, ITO/AlNiLa/ITO and ITO/AlNiLa. Therefore, the third power source supply line VrefL may also be formed of any material selected from the group consisting of ITO/Ag/ITO, ITO/Al/ITO, ITO/AlNiLa/ITO and ITO/AlNiLa. That is, the material for forming the anode electrode 271 may also be used for an internal wire of the third power source supply line Vref.

In some embodiments, it has been described that the third power source supply line VrefL is formed of the same material and in the same layer as that of the anode electrode 271. However, the present invention is not limited thereto. For example, the third power source supply line VrefL may be connected to the pixel circuit 242 through a via hole or the like by positioning another wire having a current path formed thereon, i.e., a scan, data or emission control line, in an upper layer of the pixel circuit 242, i.e., the layer in which the anode electrode 271 of the organic light emitting diode 270 and the like are formed.

For convenience of illustration, it has been shown in FIG. 4 that the organic light emitting diode 270 is disposed to overlap with the capacitor 230 formed below the organic light emitting diode 270. However, in the case of a back emission type, the organic light emitting diode 270 may be disposed not to overlap with the pixel circuit 242. In the case of a front emission type, the organic light emitting diode 270 may also be disposed not to overlap with the pixel circuit 242, depending on their design.

FIG. 5 is a circuit diagram illustrating another embodiment of the pixel illustrated in FIG. 1. For convenience of illustration, a pixel positioned on an i-th row (the “i” is a natural number) and a j-th column (the “j” is a natural number) is illustrated in FIG. 5.

Referring to FIG. 5, the pixel 140′ of this embodiment includes a pixel circuit 142′ having a plurality of transistors T1 to T6 and a storage capacitor Cst, and an organic light emitting diode OLED for receiving driving current supplied from the pixel circuit 142′.

When a previous scan signal is supplied from a previous scan line Si-1, the pixel circuit 142′ initializes a voltage stored in the storage capacitor Cst. When a current scan signal is supplied from a current scan line Si, the pixel circuit 142′ stores a data signal voltage and a voltage corresponding to the threshold voltage of the first transistor T1 in the storage capacitor Cst. Then, the pixel circuit 142′ supplies a driving current, corresponding to the data signal, to the organic light emitting diode OLED. In such case, the driving current is unaffected by the threshold voltage of the first transistor T1.

In FIG. 5, the pixel circuit 142′ is connected to the current scan line Si, the previous scan line Si-1, an emission control line Ei, a data line Dj, a first power source ELVDD, a third power source Vinit and the organic light emitting diode OLED. The pixel circuit 142′ further includes first to sixth transistors T1 to T6 and a storage capacitor Cst.

The first transistor T1 is coupled between the first power source ELVDD and the organic light emitting diode OLED to control a driving current corresponding to a voltage applied to a gate electrode of the first transistor T1.

More specifically, a first electrode (i.e., a source electrode) of the first transistor T1 is coupled to the first power source ELVDD via the sixth transistor T6, and a second electrode (i.e., a drain electrode) of the first transistor T1 is coupled to the organic light emitting diode OLED via the fifth transistor T5. A gate electrode of the first transistor T1 is coupled to a first node N1. The first transistor T1 controls the driving current supplied to the organic light emitting diode OLED. The driving current may correspond to a voltage at the first node N1, i.e., the voltage stored in the storage capacitor Cst.

The second transistor T2 is coupled between the data line Dj and the storage capacitor Cst. When the current scan signal is supplied from the current scan line Si, the second transistor is turned on to allow a data signal to be supplied to the pixel circuit 142′.

More specifically, a first electrode of the second transistor T2 is coupled to the data line Dj, and a second electrode of the second transistor T2 is coupled to the storage capacitor Cst via the first and third transistors T1 and T3. A gate electrode of the second transistor T2 is coupled to the current scan line Si. When the current scan signal is supplied from the current scan line Si, the second transistor T2 is turned on to allow the data signal supplied from the data line Dj to be supplied to the storage capacitor Cst via the first and third transistors T1 and T3.

The third transistor T3 is coupled between the gate electrode and second electrode (drain electrode) of the first transistor T1. The third transistor T3 allows the first transistor T1 to be diode-coupled corresponding to a voltage applied to a gate electrode of the third transistor T3.

More specifically, a first electrode of the third transistor T3 is coupled to the second electrode of the first transistor T1, and a second electrode of the third transistor T3 is coupled to the gate electrode of the first transistor T1. The gate electrode of the third transistor T3 is coupled to the current scan line Si. When the current scan signal is supplied from the current scan line Si, the third transistor T3 is turned on to allow the first transistor T1 to be diode-connected.

The fourth transistor T4 is coupled between the storage capacitor Cst and the third power source Vinit. The fourth transistor T4 is turned on by the previous scan signal to allow the voltage of the third power source Vinit to be supplied to the storage capacitor Cst.

Here, the third power source Vinit does not form a current path to the organic light emitting diode as do the first power source ELVDD and the second power source ELVSS. The third power source Vinit is a power source for supplying a constant voltage to the pixel circuit 142′ during the period before the current scan signal is supplied from the current scan line Si (i.e., the period in which the previous scan signal is provided from the previous scan line Si-1). The third power source Vinit is set as an initialization power source having a lower voltage of that of the data signal, i.e., a lower voltage than the minimum voltage of the data signal.

That is, when the fourth transistor T4 is turned on, the voltage at the first node N1 is initialized as a lower voltage than the voltage of the data signal, so that the data signal is actively supplied to the first node while the first transistor T1 is diode-coupled in the forward direction during a subsequent period in which the data signal is written.

More specifically, a first electrode of the fourth transistor T4 is coupled to the first node N1, which is coupled to the storage capacitor Cst and the gate electrode of the first transistor T1, and a second electrode of the fourth transistor T4 is coupled to the third power source Vinit. A gate electrode of the fourth transistor T4 is coupled to the previous scan line Si-1. When the previous scan signal is supplied from the previous scan line Si-1, the fourth transistor T4 is turned on to connect the third power source Vinit to the first node N1. Then, the voltage of the third power source Vinit is applied to the first node N1, and the voltage at the first node N1 is initialized.

The fifth transistor T5 is coupled between the first transistor T1 and the organic light emitting diode OLED. The switching of the fifth transistor T5 is controlled by an emission control signal supplied from the emission control line Ei.

More specifically, a first electrode of the fifth transistor T5 is coupled to the second electrode of the first transistor T1, and a second electrode of the fifth transistor T5 is coupled to an anode electrode of the organic light emitting diode OLED. A gate electrode of the fifth transistor T5 is coupled to the emission control line Ei. When the voltage level of the emission control signal supplied from the emission control line Ei is a high level, the fifth transistor T5 is turned off to allow the pixel circuit 142′ to be isolated from the organic light emitting diode OLED. When the voltage level of the emission control signal is changed from the high level to a low level, the fifth transistor T5 is turned on to allow the driving current supplied from the first transistor T1 to be supplied to the organic light emitting diode OLED.

The sixth transistor T6 is coupled between the first power source ELVDD and the first transistor T1. The switching of the sixth transistor T6 is also controlled by the emission control signal supplied from the emission control line Ei.

More specifically, a first electrode of the sixth transistor T6 is coupled to the first power source ELVDD, and a second electrode of the sixth transistor T6 is coupled to the source electrode of the first transistor T1. A gate electrode of the sixth transistor T6 is coupled to the emission control line Ei. When the voltage level of the emission control signal supplied from the emission control line Ei is a high level, the sixth transistor T6 is turned off to allow the first transistor T1 to be isolated from the first power source ELVDD. When the voltage level of the emission control signal is changed from the high level to a low level, the sixth transistor T6 is turned on to connect the first transistor T1 to the first power source ELVDD.

The storage capacitor Cst is coupled between the gate electrode of the first transistor T1 and the first power source ELVDD. The storage capacitor Cst is initialized by the third power source Vinit during the period in which the previous scan signal is supplied. The storage capacitor Cst is charged with a data signal and a voltage corresponding to the threshold voltage of the first transistor T1 during the period in which the current scan signal is supplied, and then maintains the stored voltage during the period in which the pixel 140′ emits light.

The organic light emitting diode OLED is coupled between the pixel circuit 142′ and the second power source ELVSS to emit light with luminance corresponding to the driving current flowing from the first power source ELVDD to the second power source ELVSS via the pixel circuit 142′ and the organic light emitting diode OLED. The organic light emitting diode OLED includes an organic emission layer for emitting light of red, green or blue so as to generate light of the color corresponding to the driving current.

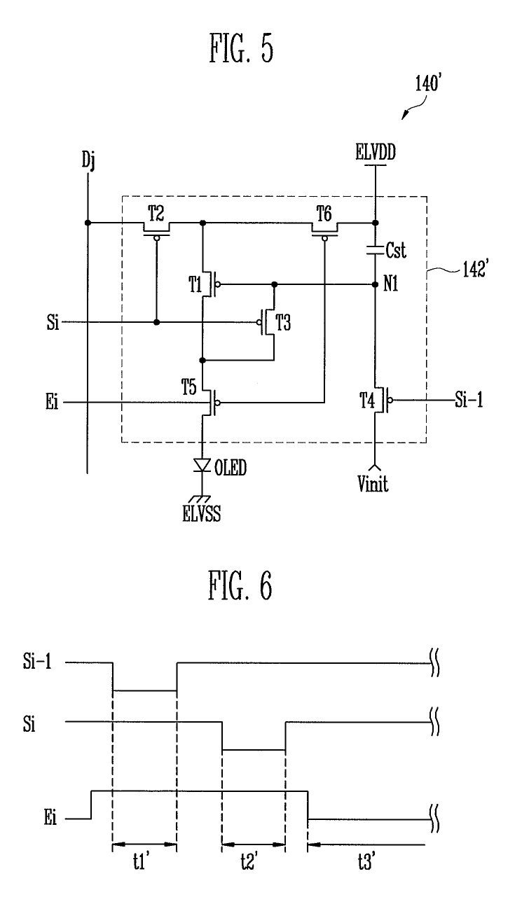

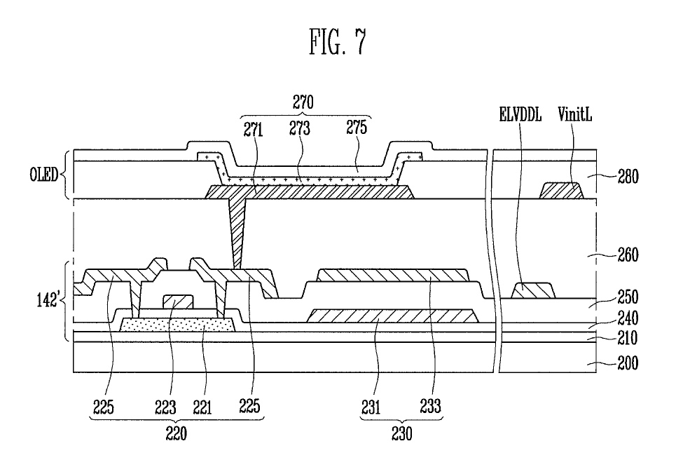

FIG. 6 is a waveform diagram illustrating a method for driving the pixel illustrated in FIG. 5 according to one embodiment of the present invention.

Referring to FIG. 6, the pixel 140′ receives low-level previous and current scan signals, sequentially supplied from the previous and current scan lines (Si-1 and Si), and receives a high-level emission control signal, supplied from the emission control line Ei. Here, the high-level emission control signal overlaps with the previous scan signal and the current scan signal.

In this case, the emission control signal maintains a high-level voltage at which the fifth and sixth transistors T5 and T6 are turned off during the periods when the previous and current scan signals are supplied. After the supply of the current scan signal is finished, the emission control signal is changed to a low-level voltage at which the fifth and sixth transistors T5 and T6 are turned on.

Meanwhile, the pixel 140′ receives the first power source ELVDD, the second power source ELVSS and the third power source Vinit. The pixel 140′ also receives a data signal from the data line Dj.

The operation of the pixel 140′ will be described in detail. First, the fourth transistor T4 is turned on during a first period t1′ where a low-level previous scan signal is supplied from the previous scan line Si-1. Then, the voltage of the third power source Vinit is supplied to the first node N1, and the voltage at the first node N1 is initialized. Accordingly, the voltage stored in the storage capacitor Cst is also initialized. That is, the first period t1′ is set as a period in which the voltage at the first node N1 is initialized.

Thereafter, the second and third transistors T2 and T3 are turned on during a second period t2′ when a low-level current scan signal is supplied from the current scan line Si. If the second and third transistors T2 and T3 are turned on, the data signal supplied from the data line Dj is supplied to the first node N1 via the second transistor T2, the first transistor T1 and the third transistor T3. Since the first transistor T1 is diode-coupled by the third transistor T3, a voltage corresponding to the data signal and the threshold voltage of the first transistor T1 is supplied to the first node N1. At this time, the voltage corresponding to the data signal and the threshold voltage of the first transistor T1 is stored in the storage capacitor Cst.

Thereafter, the fifth and sixth transistors T5 and T6 are turned on during a third period t3′ where the voltage level of the emission control signal supplied from the emission control line Ei is changed to a low level.

Then, a driving current corresponding to the voltage stored in the storage capacitor Cst is supplied to the organic light emitting diode OLED by the first transistor T1.

As the threshold voltage of the first transistor T1 is offset, driving current corresponding to the data signal is supplied to the organic light emitting diode OLED, and is unaffected by the threshold voltage of the first transistor T1. Accordingly, the organic light emitting diode OLED emits light with uniform luminance corresponding to the data signal, regardless of the threshold voltage of the first transistor T1.

FIG. 7 is a cross sectional view illustrating a portion of the pixel illustrated in FIG. 5 according to one embodiment of the present invention.

Referring to FIG. 7, a third power source supply line VinitL is formed in a different layer from that of a first power source supply line ELVDDL. Particularly, the third power source supply line VinitL is formed of the same material and in the same layer as that of the anode electrode 271 of the organic light emitting diode OLED.

Here, the third power source supply line VinitL is a wire on which a current path to the organic light emitting diode is not formed. The third power source supply line VinitL is a wire for supplying the voltage of the initialization power source Vinit to the pixel circuit 242′ during the period in which the previous scan signal is supplied. In several embodiments, pixel circuit 242′ is representative of one or more components of the pixel circuit 142′ of FIG. 5.

In FIG. 7, a thin film transistor 220 is illustrated representing the fifth transistor T5 of FIG. 5, and a capacitor 230 is illustrated representing the storage capacitor Cst of FIG. 5. Since FIG. 7 is substantially identical to FIG. 4, except that the third power source supply line VinitL supplies an initialization power source Vinit instead of a reference power source Vref, its detailed description is omitted.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device comprising:
a plurality of pixels in pixel regions defined on a substrate, each of the pixels being coupled to a current scan line, a data line, a first power source, a second power source and a third power source,
wherein each of the pixels comprises:
a pixel circuit having a plurality of transistors and one or more capacitors; and
an organic light emitting diode comprising a first electrode and coupled to the pixel circuit, the organic light emitting diode configured to emit light with a luminance corresponding to a driving current flowing from the first power source to the second power source via the pixel circuit,
wherein the third power source is configured to supply a constant voltage to the pixel circuit through a supply line, and
wherein the supply line is in a same layer and of a same material as the first electrode.

2. The organic light emitting display device according to claim 1:
wherein the third power source and the pixel circuit are configured not to provide a current path to the organic light emitting diode, and
wherein the constant voltage is supplied to the pixel circuit before a current scan signal is supplied from the current scan line.

3. The organic light emitting display device according to claim 1, wherein the first electrode of the organic light emitting diode is an anode electrode.

4. The organic light emitting display device according to claim 1, wherein a supply line of the first power source is in a different layer from the layer in which the supply line of the third power source is located.

5. The organic light emitting display device according to claim 1, wherein a supply line of the first power source is of a same material and in a same layer as an electrode of one transistor of the plurality of transistors.

6. The organic light emitting display device according to claim 5, wherein the supply line of the first power source is of the same material and in a same layer as a source electrode and a drain electrode of the one transistor of the plurality of transistors.

7. The organic light emitting display device according to claim 1, wherein the first power source is configured to provide a voltage that is higher than a voltage provided by the second power source.

8. The organic light emitting display device according to claim 7, wherein the third power source is configured to provide a different voltage than the first power source and the second power source.

9. The organic light emitting display device according to claim 1, wherein:
the pixel circuit comprises a plurality of transistors on the substrate, and one or more capacitors formed using a same material as an electrode of one of the transistors during a same process of forming the transistors; and
the organic light emitting diode is on the pixel circuit with an insulating layer interposed therebetween, and the first electrode of the organic light emitting diode is coupled to a source electrode or a drain electrode of one of the transistors through a via hole in the insulating layer.

10. The organic light emitting display device according to claim 9, wherein the organic light emitting diode comprises:
an anode electrode on the insulating layer,
an organic emission layer on the anode electrode, and
a cathode electrode on the organic emission layer, wherein the organic light emitting diode is configured to emit light in a direction of the cathode electrode.

11. The organic light emitting display device according to claim 10, wherein the anode electrode of the organic light emitting diode and the supply line of the third power source are formed of a material selected from the group consisting of ITO/Ag/ITO, ITO/Al/ITO, ITO/AlNiLa/ITO and ITO/AlNiLa.

12. The organic light emitting display device according to claim 1, wherein the pixel circuit comprises:
a first transistor coupled between the first power source and the organic light emitting diode, the first transistor configured to control the driving current corresponding to a voltage applied to a gate electrode of the first transistor;
a first capacitor coupled between the gate electrode of the first transistor and the first power source;
a second transistor coupled between the data line and the first capacitor, wherein the second transistor is configured to turn on to provide a data signal from the data line to the pixel circuit when a current scan signal is supplied from the current scan line;
a third transistor coupled between the gate electrode and a drain electrode of the first transistor, the third transistor configured to turn on so that the first transistor is diode-coupled when a voltage is applied to a gate electrode of the third transistor;
a fourth transistor coupled between the first capacitor and the third power source, the fourth transistor configured to turn on so that the voltage of the third power source is supplied to the first capacitor when a previous scan signal is supplied from a previous scan line before the current scan signal is supplied; and
a fifth transistor coupled between the first transistor and the organic light emitting diode, the fifth transistor configured to turn on when an emission control signal is supplied from an emission control line.

13. The organic light emitting display device according to claim 12, wherein the voltage of the third power source is set to a higher voltage than that of the data signal.

14. The organic light emitting display device according to claim 13, wherein the pixel circuit further comprises a second capacitor coupled between the gate electrode of the first transistor and an electrode of the first capacitor.

15. The organic light emitting display device according to claim 14, wherein the emission control signal is changed to a voltage level at which the fifth transistor is turned off after the previous scan signal is started, and is changed to a voltage level at which the fifth transistor is turned on after the current scan signal is finished.

16. The organic light emitting display device according to claim 12, wherein the voltage of the third power source is lower than that of the data signal.

17. The organic light emitting display device according to claim 16, wherein the pixel circuit further comprises a sixth transistor coupled between the first power source and the first transistor, wherein the sixth transistor is controlled by the emission control signal.

18. The organic light emitting display device according to claim 17, wherein the emission control signal is changed to a first voltage at which the fifth and sixth transistors are turned off during a period in which the previous and current scan signals are supplied, and is changed to a second voltage at which the fifth and sixth transistors are turned on after the current scan signal is supplied.
